(19) United States
(12) Patent Application Publication
(10) Pub. No.: US 2007/0266267 A1
(43) Pub. Date: Nov. 15, 2007

(54) Virtual sleep method

(75) Inventors: Nan-Kun Lo, Taipei (TW); Cheng-Kai Tsai, Taipei (TW); Ke-Chih Liao, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/798,155

(22) Filed: May 10, 2007

(30) Foreign Application Priority Data
May 12, 2006 (TW) 95116989

(51) Int. Cl. G06F 1/32

(52) U.S. Cl. 713/320

(57) ABSTRACT

First, an application program is executed on a computer, and then a virtual sleep request is received. Next, the configuration of a CPU, built in the computer, is saved to a RAM. Finally, both the processing speed and the core voltage of the CPU are reduced, and the application program originally executed on the computer continues to run.

### RELATED APPLICATIONS

This application claims priority to Taiwan Application Serial Number 95116989, filed May 12, 2006, which is herein incorporated by reference.

### BACKGROUND

1. Field of Invention

The present invention relates to a computer with a sleep function. More particularly, the present invention relates to a virtual sleep method.

2. Description of Related Art

Rapid advancement of semiconductor manufacture technology and integrated circuit design enable the wide use of commercial personal computers by individuals, families, science institutes, businesses or industries. Moreover, as with the development of internet technology and video and sound technology, the personal computer is not only an assistant to help consumers work smart but plays an important role in family entertainment.

Although computers are increasingly more important today, the computer starting time is still disliked by many consumers. Generally, the starting time of a typical computer is about 30 seconds, which is longer than the starting time of other electrical appliances. Such a long time is unpleasant for the consumers.

In order to avoid waiting for the long starting time, many users are used to turning on the computer over a long period of time to prevent starting the computer. However, the power consumption of the computer is higher than the power consumption of other electrical appliances. As energy prices soar, this method costs more and more money.

For the forgoing reasons, there is a need for a good solution to solve the mentioned problems for manufacturers.

### SUMMARY

It is therefore an aspect of the present invention to provide a virtual sleep method for a computer. The virtual sleep method defines a virtual sleep state, which reduces the processing speed and the core voltage of the central processing unit (CPU), and the application program originally executed on the computer continues to run when the computer is in this virtual sleep state.

According to one preferred embodiment of the present invention, a virtual sleep method for a computer is provided. First, an application program is executed on the computer, and then a virtual sleep request is received. Next, the configuration of a CPU, built in the computer, is saved to a random-access memory (RAM). Finally, both the processing speed and the core voltage of the CPU are reduced, and the application program originally executed on the computer continues to run.

In conclusion, the virtual sleep method according to the mentioned embodiment defines a virtual sleep state, which reduces the processing speed and the core voltage of the CPU, but the application program originally executed on the computer continues to run when the computer is in this virtual sleep state. Therefore, the computer in the virtual sleep state can saves more power, and time needed to wake up the computer from the virtual sleep state can be reduced as well. In addition, users can use the application program when the computer is in the virtual sleep state because the application program originally executed on the computer continues to run.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A-1B are diagrams showing a computer; and

FIGS. 2A-2C are flow charts illustrating the virtual sleep method according to plural preferred embodiments of this invention.

### DESCRIPTION OF THE PREFERRED EMBODIMENTS

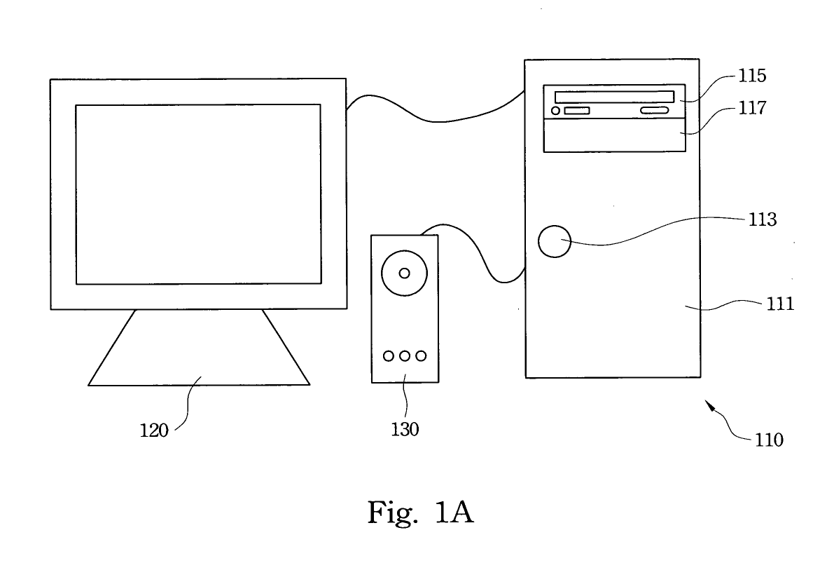

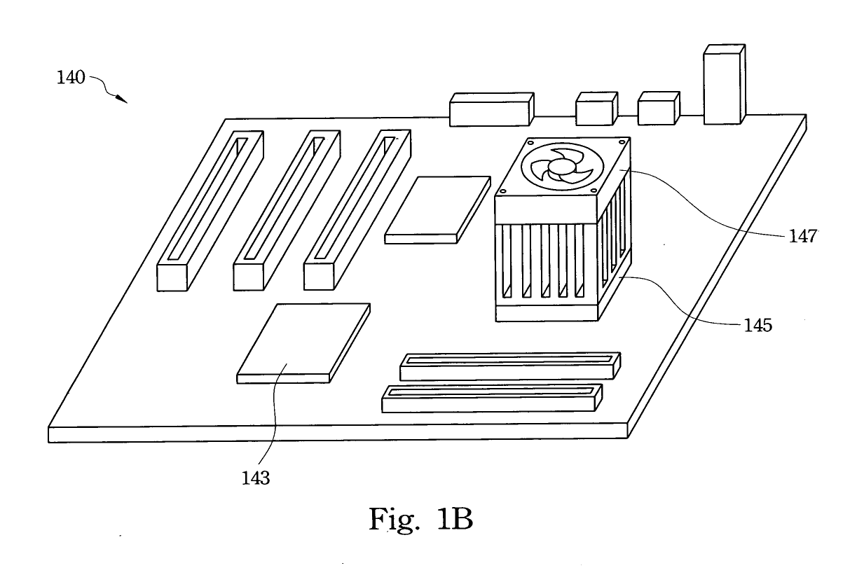

In order to explicitly illustrate the preferred embodiments of the present invention, please refer to FIG. 1A first. FIG. 1A is a diagram showing a computer. As shown in FIG. 1A, the computer includes a host 110, a sound output device 130 and a monitor 120. The monitor 120 displays images according to a video signal transmitted from the host 110. The sound output device 130 outputs sound according to a sound signal transmitted from the host 110. The host 110 may have a case 111, a motherboard (not shown), a compact disk (CD) drive 115 (or a DVD drive) and a hard disk drive 117. The case 111 has a power button 113 positioned thereon to turn on or turn off the computer. The CD drive 115 and the hard disk drive 117 are electrically connected to the motherboard respectively for storing data.

Reference is made to FIG. 1B, which shows the motherboard 140, configured in the host 110 shown in FIG. 1A. As shown in FIG. 1B, a CPU 145, a fan 147 and a south bridge chipset 143 are mounted on the motherboard 140. The CPU 145 is responsible for the operation and the control of the computer. The fan 147 is used to cool the CPU 145. The south bridge chipset 143 controls some peripheral devices of the computer with low processing speed.

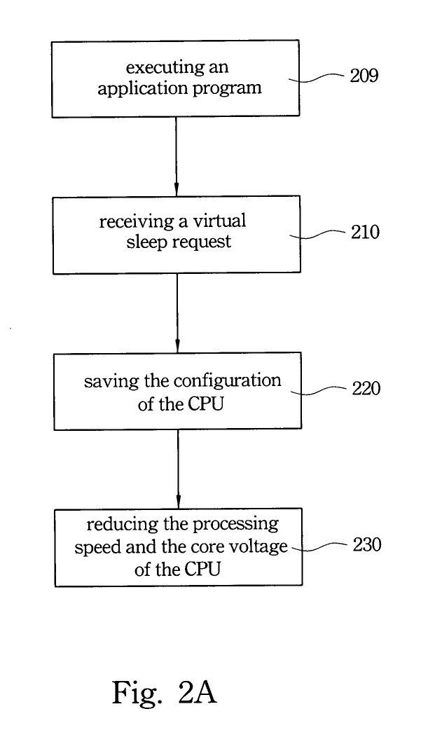

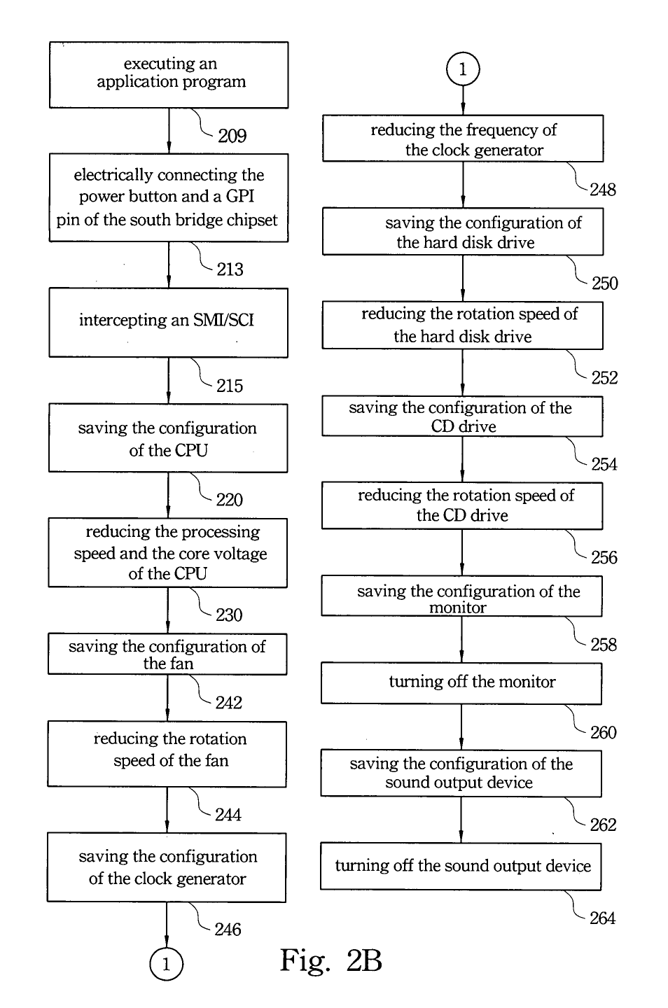

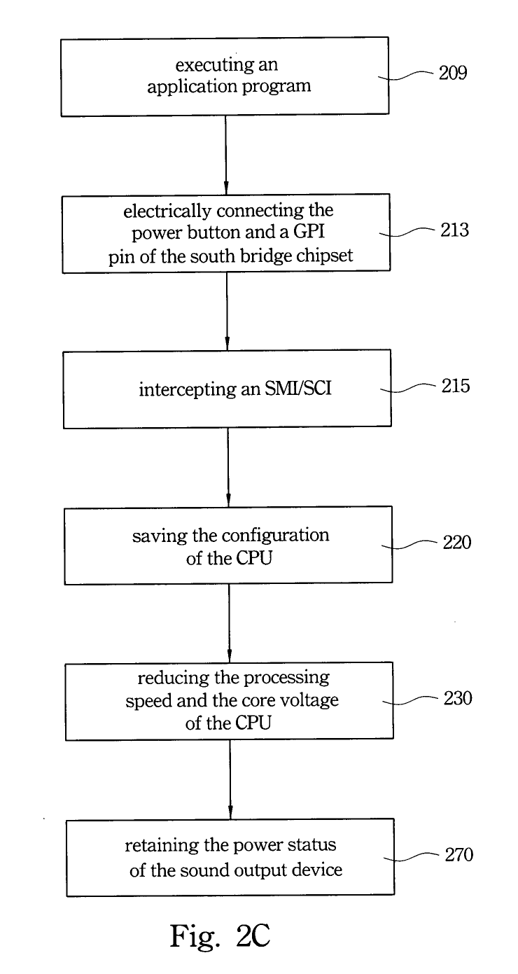

Reference is made to FIG. 2A, which is a flow chart illustrating a virtual sleep method according to one preferred embodiment of the present invention. The virtual sleep method includes the following steps: First, an application program is executed on the computer (step 209). For example, the step 209 may be playing mp3 music with any kind of software, downloading data files through the internet, using browsers or file transfer protocol (FTP) applications. Then, a virtual sleep request is received (step 210). Next, the configuration of the CPU (the CPU 145 shown in FIG. 1B), built in the computer, is saved to a RAM (step 220). Finally, both the processing speed and the core voltage of the CPU are reduced (step 230), and the application program originally executed on the computer continues to run.

In other words, the virtual sleep method defines a virtual sleep state, which reduces the processing speed and the core voltage of the CPU, and the application program originally executed on the computer continues to run when the computer is in the virtual sleep state. Reducing the processing speed and the core voltage of the CPU can save a lot of power because the CPU takes most of the power consumption of computer. Moreover, even if both the processing speed and the core voltage of the CPU are reduced, users can use the application program when the computer is in the virtual sleep state because the application program originally executed on the computer continues to run. For example, the users can play mp3 music or download data files when the computer is in the virtual sleep method.

Reference is made to FIG. 2B, which is a flow chart illustrating a virtual sleep method according to another preferred embodiment of the present invention. In this embodiment, the power button (the power button 113 shown in FIG. 1A), positioned on the case of the computer, is electrically connected to a general-purpose input (GPI) pin of the south bridge chipset (the south bridge chipset 143 shown in FIG. 1B), built in the computer (step 213). Accordingly, an system management interrupt/system control interrupt (SMI/SCI), generated from the south bridge chipset, can be intercepted as the virtual sleep request when the power button is pushed (step 215). Therefore, users can, like other electrical appliances, make the computer enter the virtual sleep state by pushing the power button. However, this should not limit the scope of the invention, and the virtual sleep request may be triggered by software, infrared rays or a remote control.

In this embodiment, the heat of the CPU is decreased because both the processing speed and the core voltage of the CPU are reduced. Therefore, the configuration of the fan (the fan 147 shown in FIG. 1B), built in the computer, may be saved to the RAM after the virtual sleep request is received (step 242). Then, the rotation speed of the fan is reduced, such that the rotation speed of the fan can correspond to the processing speed of the CPU (step 244). Generally, reducing the rotation speed of the fan can decrease the noise generated by the computer significantly because the fan is the main noise source of the computer. Furthermore, the step 244 would not raise the temperature of the CPU because both the processing speed and the core voltage of the CPU have been reduced.

After reducing the processing speed and the core voltage of the CPU, the configuration of a clock generator, built in the computer, may be saved to the RAM (step 246). Then, the frequency of the clock generator is reduced (step 248). Generally, users would not execute too many complicated application programs when the computer is in the virtual sleep state. Therefore, reducing the frequency of the clock generator at this moment can save some power and would not significantly affect the efficiency of the computer.

Moreover, the configuration of the hard disk drive (the hard disk drive 117 shown in FIG. 1A), built in the computer, may be saved to the RAM after the virtual sleep request is received (step 250). Then, the rotation speed of the hard disk drive is reduced (step 252). Reducing the rotation speed of the hard disk drive can decrease the noise generated by the computer significantly because the hard disk drive is one of the noise sources of the computer.

In order to make the computer more quiet in the virtual sleep state, the configuration of the CD drive (the CD drive 115 shown in FIG. 1A), built in the computer, may be saved to the RAM after the virtual sleep request is received (step 254). Then, the rotation speed of the CD drive is reduced (step 256).

Generally, the monitor (the monitor 120 shown in FIG. 1A) is one of the major power consuming components of the computer, and the monitor is seldom used when the computer is in the virtual sleep state. Therefore, the configuration of the monitor, attached to the computer, may be saved to the RAM after the virtual sleep request is received (step 258). Then, the monitor is turned off (step 260). Accordingly, the power consumption of the computer can be reduced without interfering with normal use.

Moreover, in order to make the computer in the virtual sleep state more energy-conservative, the configuration of the sound output device (the sound output device 130 shown in FIG. 1A), attached to the computer, may be saved to the RAM after the virtual sleep request is received (step 262). Then, the sound output device is turned off (step 264).

Reference is made to FIG. 2C, which is a flow chart illustrating a virtual sleep method according to still another preferred embodiment of the present invention. As shown in FIG. 2C, the power status of the sound output device, attached to the computer, is retained after the virtual sleep request is received (step 270). That is, the sound output device may continue to run. Accordingly, the computer can provide a sound output service, such as playing digital music, even when the computer is in the virtual sleep state.

The following compares the virtual sleep state, defined by the mentioned embodiments of the present invention, with S1, S3, S4 and S5 states, defined by advance configuration and power interface (ACPI) specification, for illustrating the computer in the virtual sleep state is more energy-conservative than the others. Furthermore, time needed to wake up the computer from the virtual sleep state is faster than the others as well. First, the configuration of the monitor, the sound output device, the hard disk drive, the CD drive, the fan, the clock generator and the CPU of the computer is saved to the RAM. Then, the monitor and the sound output device is turned off, the rotation speed of the fan, the hard disk drive and the CD drive is reduced, the frequency of the clock generator is reduced, and both the processing speed and the core voltage of the CPU are reduced to make the computer enter the virtual sleep state. The application program originally executed on the computer still continues to run when the computer is in the virtual sleep state. The configuration of the mentioned devices is recalled from the RAM, and then the mentioned devices are restored when the computer is roused.

When the computer is in S1 state, the configuration of all devices (such as the CPU, the chip set or other devices) is not lost. Only the monitor and the sound output device of the computer are turned off, such that the computer can be woken up quickly. When the computer is in S3 state, the configuration of all devices is saved to the RAM, and the configuration of all devices is recalled from the RAM when the computer is woken up. Almost all of the devices are turned off when the computer is in S3 state except some devices which use backup power and the RAM. When the computer is in S4 state, the configuration of all devices is saved to the hard disk, and the configuration of all devices is recalled from the hard disk when the computer is woken up. S5 state means that the computer is turned off.

The rank of time needed to wake up the computer form the mentioned five states and the power consumption when the computer is in the mentioned five states are listed in Table 1. Furthermore, whether an application program can be executed when the computer is in the mentioned five states is listed in Table 1 as well. The smaller the number listed in Table 1, the less power is needed, or the faster the computer can be woken up.

TABLE 1
Comparison of the prior art and the virtual sleep state

| | Virtual Sleep | | | | |
|---|---|---|---|---|---|
| | State | S1 | S3 | S4 | S5 |
| Power | 3 | 4 | 2 | 1 | 1 |
| consumption | | | | | |
| Wake up | 1 | 2 | 3 | 4 | 5 |
| Time | | | | | |
| Can Any | Yes | No | No | No | No |
| Application | | | | | |
| Program Is | | | | | |
| Executed | | | | | |
| on The | | | | | |
| Computer? | | | | | |

As listed in Table 1, time needed to wake up the computer from the virtual sleep state is less than the prior art. Actually, time needed to wake up the computer from the virtual sleep state is less than 1 second. Furthermore, the computer in the virtual sleep state consumes less power than the S1 state. In addition, regarding the mentioned five states, the application program can be executed on the computer only when the computer is in the virtual sleep state. Therefore, the computer in the virtual sleep state saves more power and the time needed to wake up the computer from the virtual sleep state is reduced as well. In addition, users can use the application program when the computer is in the virtual sleep state because the application program originally executed on the computer continues to run.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A virtual sleep method for a computer, wherein the computer has a central processing unit, the virtual sleep method comprising the steps of:
executing an application program on the computer;
receiving a virtual sleep request;
saving the configuration of the central processing unit to a random-access memory after the virtual sleep request is received; and
reducing the processing speed and the core voltage of the central processing unit, wherein the application program executed on the computer continues to run.

2. The virtual sleep method of claim 1, further comprising the step of:
electrically connecting a power button, positioned on a case of the computer, and a general-purpose input pin of a south bridge chipset, built in the computer, wherein the step of receiving the virtual sleep request comprises intercepting an system management interrupt system control interrupt (SMI/SCI) generated from the south bridge chipset as the virtual sleep request when the power button is pushed.

3. The virtual sleep method of claim 1, further comprising the step of:
saving the configuration of a fan, built in the computer, to the random-access memory after the virtual sleep request is received; and
reducing the rotation speed of the fan after the configuration of the fan is saved, such that the rotation speed of the fan corresponds to the processing speed of the central processing unit.

4. The virtual sleep method of claim 1, further comprising the step of:
saving the configuration of a clock generator, built in the computer, to the random-access memory after the virtual sleep request is received; and
reducing the frequency of the clock generator after the configuration of the clock generator is saved.

5. The virtual sleep method of claim 1, further comprising the step of:
saving the configuration of a hard disk drive, built in the computer, to the random-access memory after the virtual sleep request is received; and
reducing the rotation speed of the hard disk drive after the configuration of the hard disk drive is saved.

6. The virtual sleep method of claim 1, further comprising the step of:
saving the configuration of a compact disk drive, built in the computer, to the random-access memory after the virtual sleep request is received; and
reducing the rotation speed of the compact disk drive after the configuration of the compact disk drive is saved.

7. The virtual sleep method of claim 1, further comprising the step of:
saving the configuration of a sound output device, attached to the computer, to the random-access memory after the virtual sleep request is received; and
turning off the sound output device after the configuration of the sound output device is saved.

8. The virtual sleep method of claim 1, further comprising the step of:
retaining the power status of a sound output device, attached to the computer, after the virtual sleep request is received.

9. The virtual sleep method of claim 1, further comprising the step of:
saving the configuration of a monitor, attached to the computer, to the random-access memory after the virtual sleep request is received; and
turning off the monitor after the configuration of the monitor is saved.
